(19) United States
(12) Patent Application Publication
(10) Pub. No.: US 2022/0350901 A1
(43) Pub. Date: Nov. 3, 2022

(54) METHODS, APPARATUS AND ARTICLES OF MANUFACTURE FOR CONFIDENTIAL SKETCH PROCESSING

(71) Applicant: The Nielsen Company (US), LLC, New York, NY (US)

(72) Inventors: Ali Shiravi, Markham (CA); Amir Khezrian, Toronto (CA); Dale Karp, Richmond Hill (CA); Amin Avanessian, Holland Landing (CA)

(21) Appl. No.: 17/735,996

(22) Filed: May 3, 2022

Related U.S. Application Data
(60) Provisional application No. 63/183,608, filed on May 3, 2021.

(51) Int. Cl. G06F 21/62; H04L 9/40

(52) U.S. Cl. CPC G06F 21/62; H04L 63/166; H04L 63/126

(57) ABSTRACT

Methods, apparatus, systems, and articles of manufacture are disclosed to perform confidential sketch processing. An example apparatus includes token handler circuitry to establish trust with a publisher, sketch handler circuitry to obtain user monitoring data from the publisher and process the user monitoring data, and data transmitter circuitry to send a portion of the processed user monitoring data to an audience measurement entity controller.

### RELATED APPLICATION

This patent arises from a patent application that claims the benefit of U.S. Provisional Patent Application No. 63/183,608, which was filed on May 3, 2021. U.S. Provisional Patent Application No. 63/183,608 is hereby incorporated herein by reference in its entirety. Priority to U.S. Provisional Patent Application No. 63/183,608 is hereby claimed.

### FIELD OF THE DISCLOSURE

This disclosure relates generally to network security and, more particularly, to methods, apparatus, and articles of manufacture for confidential sketch processing.

### BACKGROUND

Traditionally, audience measurement entities determine audience engagement levels for media programming based on registered panel members. That is, an audience measurement entity enrolls people who consent to being monitored into a panel. The audience measurement entity then monitors those panel members to determine media (e.g., television programs or radio programs, movies, DVDs, advertisements, etc.) exposed to those panel members. In this manner, the audience measurement entity can determine exposure measures for different media based on the collected media measurement data. Techniques for monitoring user access to Internet resources such as web pages, advertisements and/or other media have evolved significantly over the years. Some prior systems perform such monitoring primarily through server logs. In particular, entities serving media on the Internet can use such prior systems to log the number of requests received for their media at their server.

### BRIEF DESCRIPTION OF THE DRAWINGS

FIG. 1 is a block diagram of an example environment in which media data is aggregated.

FIG. 2 is a block diagram illustrating an example system.

FIG. 3 is a block diagram of an example sketch service.

FIGS. 4-7 are flowcharts representative of example machine readable instructions and/or example operations that may be executed by example processor circuitry to implement the sketch service of FIGS. 2 and/or 3.

FIG. 8 is a block diagram illustrating example attacks which may be attempted on an example system.

FIG. 9 is a flowchart illustrating an example attack which may be attempted on an example system.

FIG. 10 is a flowchart illustrating an example attack which may be attempted on an example system.

FIG. 11 is a block diagram of an example processing platform including processor circuitry structured to execute the example machine readable instructions and/or the example operations of FIGS. 4-7 to implement the sketch service of FIGS. 2 and/or 3.

FIG. 12 is a block diagram of an example implementation of the processor circuitry of FIG. 11.

FIG. 13 is a block diagram of another example implementation of the processor circuitry of FIG. 11.

FIG. 14 is a block diagram of an example software distribution platform (e.g., one or more servers) to distribute software (e.g., software corresponding to the example machine readable instructions of FIGS. 4-7) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

As used herein, “approximately” and “about” refer to dimensions that may not be exact due to manufacturing tolerances and/or other real world imperfections. As used herein “substantially real time” refers to occurrence in a near instantaneous manner recognizing there may be real world delays for computing time, transmission, etc. Thus, unless otherwise specified, “substantially real time” refers to real time+/−1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmed with instructions to perform specific operations and including one or more semiconductor-based logic devices (e.g., electrical hardware implemented by one or more transistors). Examples of processor circuitry include programmed microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of the processing circuitry is/are best suited to execute the computing task(s).

### DETAILED DESCRIPTION

Techniques for monitoring user accesses to Internet-accessible media, such as advertisements and/or content, via digital television, desktop computers, mobile devices, etc. have evolved significantly over the years. Internet-accessible media is also known as digital media. In the past, such monitoring was done primarily through server logs. In particular, entities serving media on the Internet would log the number of requests received for their media at their servers. Basing Internet usage research on server logs is problematic for several reasons. For example, server logs can be tampered with either directly or via zombie programs, which repeatedly request media from the server to increase the server log counts. Also, media is sometimes retrieved once, cached locally and then repeatedly accessed from the local cache without involving the server. Server logs cannot track such repeat views of cached media. Thus, server logs are susceptible to both over-counting and under-counting errors.

The inventions disclosed in Blumenau, U.S. Pat. No. 6,108,637, which is hereby incorporated herein by reference in its entirety, fundamentally changed the way Internet monitoring is performed and overcame the limitations of the server-side log monitoring techniques described above. For example, Blumenau disclosed a technique wherein Internet media to be tracked is tagged with monitoring instructions. In particular, monitoring instructions are associated with the hypertext markup language (HTML) of the media to be tracked. When a client requests the media, both the media and the monitoring instructions are downloaded to the client. The monitoring instructions are, thus, executed whenever the media is accessed, be it from a server or from a cache. Upon execution, the monitoring instructions cause the client to send or transmit monitoring information from the client to a content provider site. The monitoring information is indicative of the manner in which content was displayed.

In some implementations, an impression request or ping request can be used to send or transmit monitoring information by a client device using a network communication in the form of a hypertext transfer protocol (HTTP) request. In this manner, the impression request or ping request reports the occurrence of a media impression at the client device. For example, the impression request or ping request includes information to report access to a particular item of media (e.g., an advertisement, a webpage, an image, video, audio, etc.). In some examples, the impression request or ping request can also include a cookie previously set in the browser of the client device that may be used to identify a user that accessed the media. That is, impression requests or ping requests cause monitoring data reflecting information about an access to the media to be sent from the client device that downloaded the media to a monitoring entity and can provide a cookie to identify the client device and/or a user of the client device. In some examples, the monitoring entity is an audience measurement entity (AME) that did not provide the media to the client and who is a trusted (e.g., neutral) third party for providing accurate usage statistics (e.g., The Nielsen Company, LLC). Since the AME is a third party relative to the entity serving the media to the client device, the cookie sent to the AME in the impression request to report the occurrence of the media impression at the client device is a third-party cookie. Third-party cookie tracking is used by measurement entities to track access to media accessed by client devices from first-party media servers.

There are many database proprietors operating on the Internet. These database proprietors provide services to large numbers of subscribers. In exchange for the provision of services, the subscribers register with the database proprietors. Examples of such database proprietors include social network sites (e.g., Facebook, Twitter, MySpace, etc.), multi-service sites (e.g., Yahoo!, Google, Axiom, Catalina, etc.), online retailer sites (e.g., Amazon.com, Buy.com, etc.), credit reporting sites (e.g., Experian), streaming media sites (e.g., YouTube, Hulu, etc.), etc. These database proprietors set cookies and/or other device/user identifiers on the client devices of their subscribers to enable the database proprietors to recognize their subscribers when they visit their web sites.

The protocols of the Internet make cookies inaccessible outside of the domain (e.g., Internet domain, domain name, etc.) on which they were set. Thus, a cookie set in, for example, the facebook.com domain (e.g., a first party) is accessible to servers in the facebook.com domain, but not to servers outside that domain. Therefore, although an AME (e.g., a third party) might find it advantageous to access the cookies set by the database proprietors, they are unable to do so.

The inventions disclosed in Mazumdar et al., U.S. Pat. No. 8,370,489, which is incorporated by reference herein in its entirety, enable an AME to leverage the existing databases of database proprietors to collect more extensive Internet usage by extending the impression request process to encompass partnered database proprietors and by using such partners as interim data collectors. The inventions disclosed in Mazumdar accomplish this task by structuring the AME to respond to impression requests from clients (who may not be a member of an audience measurement panel and, thus, may be unknown to the AME) by redirecting the clients from the AME to a database proprietor, such as a social network site partnered with the AME, using an impression response. Such a redirection initiates a communication session between the client accessing the tagged media and the database proprietor. For example, the impression response received at the client device from the AME may cause the client device to send a second impression request to the database proprietor. In response to the database proprietor receiving this impression request from the client device, the database proprietor (e.g., Facebook) can access any cookie it has set on the client to thereby identify the client based on the internal records of the database proprietor. In the event the client device corresponds to a subscriber of the database proprietor, the database proprietor logs/records a database proprietor demographic impression in association with the user/client device.

As used herein, a panelist is a member of a panel of audience members that have agreed to have their accesses to media monitored. That is, an entity such as an audience measurement entity enrolls people that consent to being monitored into a panel. During enrollment, the audience measurement entity receives demographic information from the enrolling people so that subsequent correlations may be made between advertisement/media exposure to those panelists and different demographic markets.

As used herein, an impression is defined to be an event in which a home or individual accesses and/or is exposed to media (e.g., an advertisement, content, a group of advertisements and/or a collection of content). In Internet media delivery, a quantity of impressions or impression count is the total number of times media (e.g., content, an advertisement, or advertisement campaign) has been accessed by a web population or audience members (e.g., the number of times the media is accessed). In some examples, an impression or media impression is logged by an impression collection entity (e.g., an AME or a database proprietor) in response to an impression request from a user/client device that requested the media. For example, an impression request is a message or communication (e.g., an HTTP request) sent by a client device to an impression collection server to report the occurrence of a media impression at the client device. In some examples, a media impression is not associated with demographics. In non-Internet media delivery, such as television (TV) media, a television or a device attached to the television (e.g., a set-top-box or other media monitoring device) may monitor media being output by the television. The monitoring generates a log of impressions associated with the media displayed on the television. The television and/or connected device may transmit impression logs to the impression collection entity to log the media impressions.

A user of a computing device (e.g., a mobile device, a tablet, a laptop, etc.) and/or a television may be exposed to the same media via multiple devices (e.g., two or more of a mobile device, a tablet, a laptop, etc.) and/or via multiple media types (e.g., digital media available online, digital TV (DTV) media temporarily available online after broadcast, TV media, etc.). For example, a user may start watching a particular television program on a television as part of TV media, pause the program, and continue to watch the program on a tablet as part of DTV media. In such an example, the exposure to the program may be logged by an AME twice, once for an impression log associated with the television exposure, and once for the impression request generated by a tag (e.g., census measurement science (CMS) tag) executed on the tablet. Multiple logged impressions associated with the same program and/or same user are defined as duplicate impressions. Duplicate impressions are problematic in determining total reach estimates because one exposure via two or more cross-platform devices may be counted as two or more unique audience members. As used herein, reach is a measure indicative of the demographic coverage achieved by media (e.g., demographic group(s) and/or demographic population(s) exposed to the media). For example, media reaching a broader demographic base will have a larger reach than media that reached a more limited demographic base. The reach metric may be measured by tracking impressions for known users (e.g., panelists or non-panelists) for which an audience measurement entity stores demographic information or can obtain demographic information. Deduplication is a process that is used to adjust cross-platform media exposure totals by reducing (e.g., eliminating) the double counting of individual audience members that were exposed to media via more than one platform and/or are represented in more than one database of media impressions used to determine the reach of the media.

As used herein, a unique audience is based on audience members distinguishable from one another. That is, a particular audience member exposed to particular media is measured as a single unique audience member regardless of how many times that audience member is exposed to that particular media or the particular platform(s) through which the audience member is exposed to the media. If that particular audience member is exposed multiple times to the same media, the multiple exposures for the particular audience member to the same media is counted as only a single unique audience member. As used herein, an audience size is a quantity of unique audience members of particular events (e.g., exposed to particular media, etc.). That is, an audience size is a number of deduplicated or unique audience members exposed to a media item of interest of audience metrics analysis. A deduplicated or unique audience member is one that is counted only once as part of an audience size. Thus, regardless of whether a particular person is detected as accessing a media item once or multiple times, that person is only counted once as the audience size for that media item. In this manner, impression performance for particular media is not disproportionately represented when a small subset of one or more audience members is exposed to the same media an excessively large number of times while a larger number of audience members is exposed fewer times or not at all to that same media. Audience size may also be referred to as unique audience or deduplicated audience. By tracking exposures to unique audience members, a unique audience measure may be used to determine a reach measure to identify how many unique audience members are reached by media. In some examples, increasing unique audience and, thus, reach, is useful for advertisers wishing to reach a larger audience base.

An AME may want to find unique audience/deduplicate impressions across multiple database proprietors, custom date ranges, custom combinations of assets and platforms, etc. Some deduplication techniques perform deduplication across database proprietors using particular systems (e.g., Nielsen's TV Panel Audience Link). For example, such deduplication techniques match or probabilistically link personally identifiable information (PII) from each source. Such deduplication techniques require storing massive amounts of user data or calculating audience overlap for all possible combinations, neither of which are desirable. PII data can be used to represent and/or access audience demographics (e.g., geographic locations, ages, genders, etc.).

In some situations, while the database proprietors may be interested in collaborating with an AME, the database proprietor may not want to share the PII data associated with its subscribers to maintain the privacy of the subscribers. One solution to the concerns for privacy is to share sketch data that provides summary information about an underlying dataset without revealing PII data for individuals that may be included in the dataset. Not only does sketch data assist in protecting the privacy of users represented by the data, sketch data also serves as a memory saving construct to represent the contents of relatively large databases using relatively small amounts of data. Further, not only does the relatively small size of sketch date offer advantages for memory capacity but it also reduces demands on processor capacity to analyze and/or process such data.

Notably, although third-party cookies are useful for third-party measurement entities in many of the above-described techniques to track media accesses and to leverage demographic information from third-party database proprietors, use of third-party cookies may be limited or may cease in some or all online markets. That is, use of third-party cookies enables sharing anonymous subscriber information (without revealing personally identifiable information (PII)) across entities which can be used to identify and deduplicate audience members across database proprietor impression data. However, to reduce or eliminate the possibility of revealing user identities outside database proprietors by such anonymous data sharing across entities, some websites, internet domains, and/or web browsers will stop (or have already stopped) supporting third-party cookies. This will make it more challenging for third-party measurement entities to track media accesses via first-party servers. That is, although first-party cookies will still be supported and useful for media providers to track accesses to media via their own first-party servers, neutral third parties interested in generating neutral, unbiased audience metrics data will not have access to the impression data collected by the first-party servers using first-party cookies. Examples disclosed herein may be implemented with or without the availability of third-party cookies because, as mentioned above, the datasets used in the deduplication process are generated and provided by database proprietors, which may employ first-party cookies to track media impressions from which the datasets (e.g., sketch data) is generated.

In some examples, the AME directly monitors usage of digital media. In other examples, the AME gathers user monitoring data from third-party publishers (e.g., media providers). In some of these examples, the AME gathers and aggregates user monitoring data (e.g., sketch data) from multiple publishers in order to obtain a larger audience sample size. For data from multiple publishers to be aggregated, the user monitoring data (e.g., sketch data) must contain accurate and sufficient information regarding the users (e.g., audience members). Without such information in the user monitoring data, it may be difficult or not possible to determine an accurate aggregated audience (e.g., one in which duplicated audience members are not double counted, a unique audience, etc.).

In some examples, the third-party publishers (e.g., media providers) are hesitant to provide accurate and sufficient data sets of user monitoring data. The third-party publishers may wish to protect their users' privacy and thus may provide only incomplete (e.g., not including all known user monitoring data, not including known user information, etc.) or inaccurate (e.g., including inaccurate user information) user monitoring data to the AME. As established above, such incomplete or inaccurate user monitoring data cannot be used to determine accurate aggregated user monitoring data.

In some examples, a third-party publisher can utilize user monitoring data formatted as sketch data to share the user monitoring data with the AME. While the user monitoring data sketch data can contain user data (e.g., monitoring data, user demographic information, user personally identifiable information (PII)), the user data included in the sketch is not directly queryable. In other words, although the AME has been provided a sketch from a third-party publisher containing user data, the AME may not have access to a queryable list of all the information contained in the sketch. In some examples, the sketch may only return a derived value (e.g., a calculated value, a probabilistic value, etc.) in response to a request in order to maintain the privacy of the user data contained in the sketch. In these examples, it is difficult for the AME to aggregate the user data contained one sketch with other user data (e.g., user data contained in another sketch, user data in another data structure type, etc.). In other examples, the user monitoring data sketch can be a type of sketch which is more queryable than other sketch types. In these examples, the user monitoring data sketch can provide more useful information to the AME for aggregating data from multiple sketches. In these examples, the more queryable user data monitoring sketch can be used by the AME to aggregate data from multiple sources (e.g., multiple sketches from a single third-party publishers, sketches from more than one third-party publishers, data in more than one data structure type, etc.) into accurate aggregated user monitoring data.

In some examples, the third-party publisher may provide user monitoring data in a more queryable sketch type to the AME if privacy-related processing procedures are followed (e.g., the sketch is processed in a trusted, secure environment, if only previously agreed upon user data is exported to the AME, etc.). For example, the third-party entity may provide the more queryable user monitoring data sketch to the AME if the processing procedure ensures that the AME does not have access to the plain text user monitoring information containing sensitive user data. One example of a privacy-related processing procedure is collecting and performing data processing computations on the user data (e.g., sensitive user data containing PII) in a verifiable environment with strong security (e.g., encrypted memory and storage, dedicated trusted platform module (TPM), append-only logging). In some examples, third-party publishers may share user data (e.g., sensitive user data containing PII) they have collected with applications running in such verifiable environments. In these examples, communication between the third-parties and the applications running in verifiable, trusted environments regarding sensitive data can be prefaced with establishing trust with the third-party publisher. The established trust verifies that the application is following privacy-related processing procedures such as running within a secure environment, that all applications and services running in the environment have been previously approved by the third-party publisher, and that the integrity of the environment has not been affected.

Examples disclosed herein illustrate an example system to collect accurate and complete user monitoring data from multiple publishers which can be used for data aggregation. In the example system, a sketch service facilitates gathering sketches containing sensitive user data (e.g., data containing PII) from third-party publishers, performing computation on the sketches, and sending the agreed upon sketch data outputs to an AME controller. The example sketch service is owned by the AME and deployed within a secure environment such as the verifiable environment described above.

In some examples, a cloud computing environment (CCE) owns the secure environment which includes the example sketch service. The CCE may be able to independently verify properties of the secure environment. For example, the CCE can ensure that the secure environment can be trusted by the third-party providers, for example, by following privacy-related procedures. In one example of a privacy-related procedure, the CCE includes a trusted virtual machine (VM) implemented using trusted VM security features. In some examples, a privacy-related procedure includes generation of a validation report. For example, the VM can provide a validation report attesting that the VM has the trusted virtual machine security features configured to enable a trusted computing environment. In some examples, a privacy-related procedure includes verifying programs and/or applications (e.g., software) running on the VM. In these examples, the VM can provide a configuration report including a history of all runtime changes within the VM. Another example privacy-related procedure is the use of secure public key cryptography. In another example privacy-related procedure, the VM uses a secure boot and/or a trusted boot to ensure that the VM runs only verified software (e.g., code or scripts) during a boot process.

In some examples disclosed herein, an example token service is owned and deployed by each third-party publisher. The example token service is used by the third-party publisher(s) to communicate with the CCE and the sketch service. As part of an example privacy-related procedure, a source code of the sketch service is shared with the third-party publisher(s). Additionally, a reference implementation of the token service reference is shared with all parties (e.g., the CCE, the AME, the third-party publisher(s), etc.).

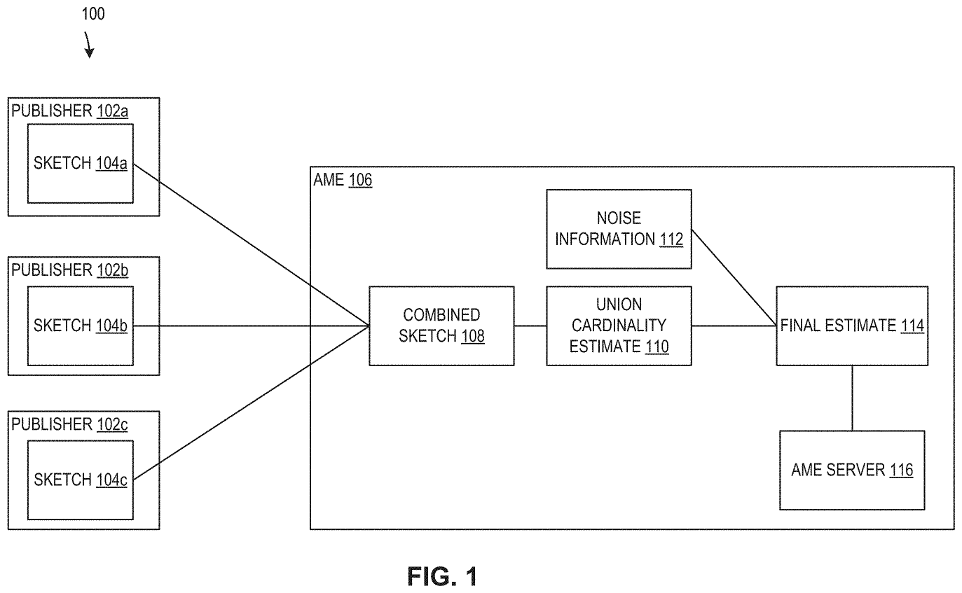

FIG. 1 illustrates an example system 100 of example media data aggregation based on sketch data. In the example system 100, a plurality of publishers 102a, 102b, 102c (e.g., third-party publishers) monitor user interactions with digital media. The plurality of publishers 102a, 102b, 102c generate a plurality of sketches 104a, 104b, 104b (e.g., data structures) including the user monitoring data. The plurality of sketches 104a, 104b, 104c are provided to an audience measurement entity (AME) 106 for aggregation. In some examples, one or more of the publishers 102a, 102b, 102c can generate more than one sketch to provide to the AME 106. In other examples, the AME can receive a plurality of sketches from a single publisher (e.g., the publisher 102a, the publisher 102b, the publisher 102c). The example AME 106 generates a combined sketch 108 including an initial aggregation of the sketches 104a, 104b, 104c provided by the publishers 102a, 102b, 102c. From the combined sketch 108, the AME 106 determines a union cardinality estimate 110 (e.g., an estimated size of the aggregated sketches). The example AME 106 combines the union cardinality estimate 110 with known noise information 112 (e.g., related to one or more of the publishers, the sketches, the user demographics, etc.) to generate a final estimate 114 of the aggregated sketch information. The final estimate 114 is provided to an AME server 116 for storage.

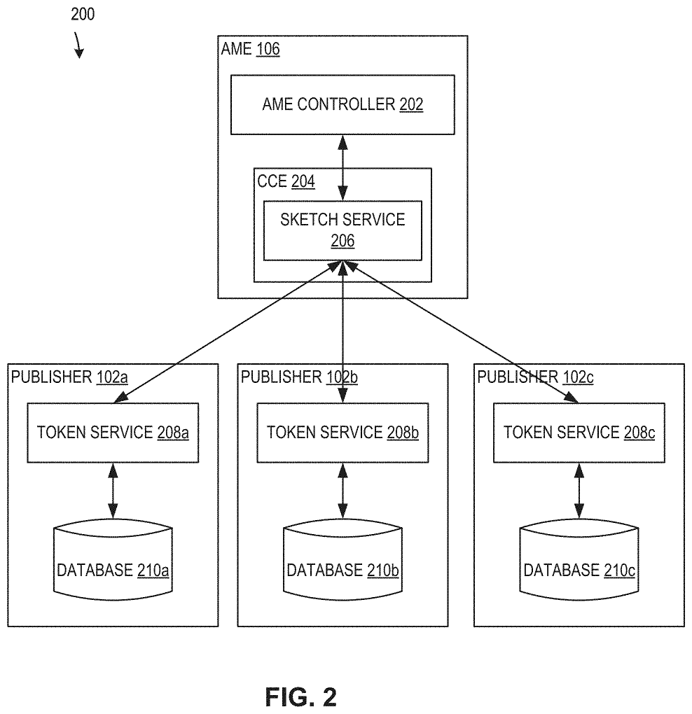

FIG. 2 illustrates an example system 200 for aggregating media data using confidential sketch processing. The example system 200 includes the AME 106 communicatively coupled to the plurality of publishers 102a, 102b, 102c. The example AME 106 includes an AME controller 202 and a cloud computing environment (CCE) 204 including a sketch service 206. The example AME controller 202 can provide job information including media for which user data should be collected and aggregated to the sketch service 206 located within the CCE 204. Additionally, the example AME controller 202 receives the outputs of the confidential sketch processing from the sketch service 206. In some examples, the AME controller 202 receives only a portion (e.g., a portion not including sensitive user data) of the outputs of the confidential sketch processing.

The example CCE 204 provides a secure environment for collecting and performing data processing computations on the user monitoring data (e.g., sensitive user data containing PII). The example CCE 204 can generate a trusted virtual machine (VM) implemented using trusted virtual machine security features. The trusted VM can implement privacy-related procedures. In some examples, the VM implements a privacy-related procedure by generating a validation report. For example, the VM can provide a validation report attesting that the VM has the trusted virtual machine security features enabled. The validation report can affirm the VM is configured to enable a trusted computing environment. In some examples, the VM implements a privacy-related procedure by verifying programs and/or applications (e.g., software) running on the VM. In these examples, the VM can provide a configuration report including a history of all runtime changes within the VM. The configuration report can include a full description of the VM configuration including, but not limited to, a base image, a bootstrap script (e.g., Cloudinit), binary checksums, network configurations, I/O resources (e.g., disks and/or network settings), and external executable programs configured (e.g., BIOS, bootstrap, initialization scripts, etc.).

Another example privacy-related procedure implemented by the VM is the use of secure public key cryptography. In this example, an exclusive private key is provided to the VM. The example private key is only accessible within the VM and a corresponding public key is publicly accessible. As a part of the example privacy-related procedure, the key pair (e.g., the private key and the public key) are created as part of VM creation. Additionally, the example key pair is destroyed when the VM is terminated. In another example privacy-related procedure, the VM uses a trusted boot to ensure that the VM runs only verified software (e.g., code or scripts) during a boot process.

The trusted VM can store data outside of a CPU in encrypted form using a unique key through a trusted hardware (e.g., a virtual trusted platform module (vTPM)). In some examples, a memory in the trusted VM is encrypted (e.g., with a dedicated per-VM instance key). In some examples, the dedicated per-VM instance key is generated by a platform security processor (PSP) during creation of the trusted VM. In some examples, the dedicated per-VM instance key resides solely within the PSP such that the CCE does not have access to the key. The vTPM can also comply with privacy-related procedures. For example, the vTPM can be compliant with Trusted Computing Group (TCG) specifications (e.g., ISO/IEC 11889). In another example, keys (e.g., root keys, keys that the vTPM generates, etc.) associated with the vTPM are kept within the vTPM. Keeping the keys associated with the vTPM within the vTPM allows for isolating the VMs and a hypervisor (e.g., software that creates and runs VMs) from one another at the hardware level. To conform with privacy-related procedures, a memory location (e.g., Platform Configuration Registers (PCRs)) within the vTPM can include an append-only log of a system state of the vTPM. As such, if the system state (e.g., hardware, firmware, and/or boot loader configuration) of the vTPM is changed, such a change can be detected within the memory location (e.g., the PCRs).

The example sketch service 206 runs within the secure environment of the CCE 204. Because the example sketch service 206 runs within the secure environment of the CCE 204, third-party publishers (e.g., the publisher 102a, the publisher 102b, the publisher 102c) share user data (e.g., sensitive user data containing PII) they have collected with the example sketch service 206. For example, because the sketch service 206 is running with in the secure environment of the CCE 204, the publishers 102a, 102b, 102c share sketches including sensitive user data with the sketch service 206. If the sketch service 206 were not running within the secure environment of the CCE 204 but only within a server of the AME 106, the publishers 102a, 102b, 102c may not share sketches including sensitive user data with the sketch service 206.

In the example of FIG. 2, communication between the publishers 102a, 102b, 102c and the sketch service 206 regarding sensitive data is prefaced with establishing trust. The established trust verifies that the sketch service 206 is following privacy-related procedures previously agreed upon between the AME 106 and the publishers 102a, 102b, 102c. For example, the privacy-related procedures can include the sketch service 206 running within a secure environment (e.g., the CCE 204), applications and services (e.g., the sketch service 206, etc.) running in the secure environment (e.g., the CCE 204) have been previously approved by the publishers 102a, 102b, 102c, and that the integrity of the secure environment (e.g., the CCE 204) has not been affected (e.g., the configuration has not been modified).

Each of the example publishers 102a, 102b, 102c includes a token service 208a, 208b, 208c. The example token services 208a, 208b, 208c are used by the third-party publisher(s) to communicate with the CCE 204 and the sketch service 206. As part of an example privacy-related procedure, a source code of the sketch service is shared with the third-party publisher(s). Additionally, a reference implementation of the token service reference is shared with all parties (e.g., the CCE, the AME, the third-party publisher(s), etc.). Each of the example publishers 102a, 102b, 102c includes a database 210a, 210b, 210c. The example databases 210a, 210b, 210c store user monitoring data generated by their respective publishers 102a, 102b, 102c. In some examples, the user monitoring data is stored as sketch data. In some examples, one or more of the databases 210a, 210b, 210c are configured as cloud storage. The example token services 208a, 208b, 208c can retrieve the user monitoring data (e.g., the sketch data) from the respective databases 210a, 210b, 210c to provide to the sketch service 206 of the AME 106.

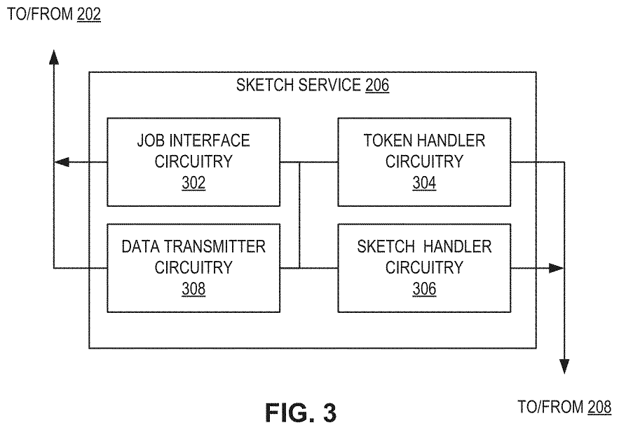

FIG. 3 is a block diagram of the example sketch service 206 to perform confidential sketch processing. The sketch service 206 of FIG. 3 may be instantiated (e.g., creating an instance of, bring into being for any length of time, materialize, implement, etc.) by processor circuitry such as a central processing unit executing instructions. Additionally or alternatively, the sketch service 206 of FIG. 3 may be instantiated (e.g., creating an instance of, bring into being for any length of time, materialize, implement, etc.) by an ASIC or an FPGA structured to perform operations corresponding to the instructions. It should be understood that some or all of the circuitry of FIG. 3 may, thus, be instantiated at the same or different times. Some or all of the circuitry may be instantiated, for example, in one or more threads executing concurrently on hardware and/or in series on hardware. Moreover, in some examples, some or all of the circuitry of FIG. 3 may be implemented by one or more virtual machines and/or containers executing on the microprocessor.

The example sketch service 206 includes example job interface circuitry 302. The example job interface circuitry 302 can retrieve job information from the AME controller 202. For example, the job information can include details regarding media for which user data should be collected and aggregated. The example job interface circuitry 302 can request the job information from the AME controller 202 and subsequently receive the job information from the AME controller 202. The example job interface circuitry 302 can request the job information periodically, aperiodically, or in response to an input. In some examples, the job interface circuitry 302 receives job information from the AME controller 202 without first sending a request.

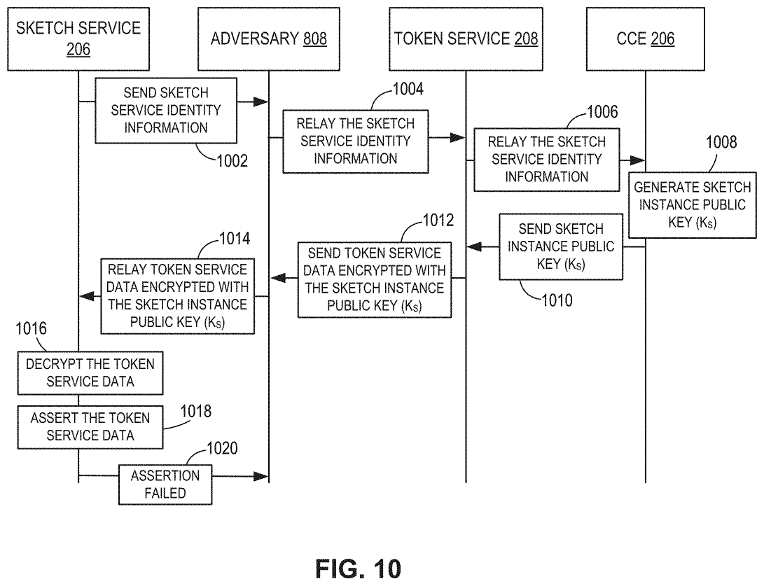

The example sketch service 206 includes token handler circuitry 304. The example token handler circuitry 304 communicates with the example token service 208 to establish trust and assert the sketch service 206. In one example, the example token handler circuitry 304 establishes trust with the token service through 208 a Transport Layer Security (TLS) handshake. In another example, the token handler circuitry 304 asserts the sketch service 206 by sending identity information of the sketch service 206 to the token service 208. In order to send the identity information of the sketch service 206 to the token service 208, the example token handler circuitry 304 first establishes a connection with the token service 208. During the establishment of the connection with the token service 208, the token handler circuitry 304 can record a Fully Qualified Domain Name (FDQN) of the token service 208 with which the token handler circuitry 304 connects. In another example of asserting the sketch service 206, the example token handler circuitry 304 receives data regarding the token service 208. The data regarding the token service 208 can include a FQDN of the entity sending the data regarding the token service 208. The example token handler circuitry 304 can assert (e.g., check) the FQDN of the entity sending the data regarding the token service 208 against the FDQN of the token service 208 with which the token handler circuitry 304 connects. If both FQDNs are the same, the assertion passes confirming that the entity sending the data regarding the token service 208 is the same as the token service 208 with which the token handler circuitry 304 originally connected. If the FQDNs are different, the assertion fails. In some examples, the assertion failing is indicative of a chuck token service masquerading as the token service 208, as described below in connection with FIG. 10.

In some examples, the data regarding the token service 208 sent to the token handler circuitry 304 is encrypted with a sketch instance public key (K_{S}). For example, the token service 208 can relay the identity information of the sketch service 206 to the CCE 204 (FIG. 2) and the CCE 204 can generate a sketch instance public key (K_{S}). The example token service 208 can encrypt the data regarding the token service 208 with the sketch instance public key (K_{S}). The example token handler circuitry 304 of the example sketch service 206 can decrypt the data regarding the token service 208 using a sketch service private key (X_{S}). The sketch service private key (X_{S}) may only be known by the sketch service 206. Therefore, if the data regarding the token service 208 is sent to any entity other than the sketch service 206, the data regarding the token service 208 cannot be decrypted.

In some examples, the data regarding the token service 208 includes an access token (τ). The example token handler circuitry 304 can retrieve (e.g., access, receive) the access token (τ). For example, during the assertion of the sketch service 206, the token handler circuitry 304 decrypts the data regarding the token service 208 using the sketch service private key (X_{S}) to retrieve the access token (τ). Further, the example token handler circuitry 304 can send the access token (τ) back to the token service 208. Because only the sketch service 206 having the sketch service private key (X_{S}) can decrypt the data regarding the token service 208, the access token (τ) can be used by the token service 208 to assert the sketch service 206.

The example sketch service 206 includes sketch handler circuitry 306. The example sketch handler circuitry 306 requests and receives sketch data from the token service 208. For example, the sketch handler circuitry 306 can send a request for sketch data to the token service 208 for sketch data. The request for sketch data can include a list of media for which the sketch handler circuitry 306 is collecting user data. The list of media can be provided to the sketch handler circuitry 306 from the job interface circuitry 302 after the job information is retrieved from the AME controller 202. The request for sketch data can also include the access token (τ) retrieved by the token handler circuitry 304 during verification of the sketch service 206. In some examples, the sketch handler circuitry 306 sends a request for sketch data to multiple token services 208a, 208b, 208c of multiple publishers 102a, 102b, 102c (FIG. 2). For example, the sketch handler circuitry 306 can request sketch data for the same list of media from the plurality of token services 208a, 208b, 208c. In another example, the sketch handler circuitry can send multiple requests for sketch data to the same token service 208. For example, the sketch handler circuitry 306 can request sketch data for the same list of media from the same token service 208 at a first time and a second time. In another example, the sketch handler circuitry 306 can request sketch data for two different lists of media from the same token service 208.

In examples disclosed herein, the sketch handler circuitry 306 can request sketch data only after 1) trust is established with the given token service 208 and 2) the sketch service 206 has been verified. Because the trust has been established with the token service 208, the sketch service 206 has been verified, and the sketch service 206 is running with in the secure environment of the CCE 204 (FIG. 2), the publishers 102a, 102b, 102c share sketch data including sensitive user data with the sketch service 206. For example, the sketch data received by the sketch handler circuitry 306 from the token service 208 includes user monitoring data linked to sensitive user data. The example sketch handler circuitry 306 is configured to process the sketch data received from the one or more token services 208. For example, the sketch handler circuitry 306 can aggregate multiple sketches into a combined sketch. Because the sketch data includes the user monitoring data linked to sensitive user data, the sketch handler circuitry 306 is able to accurately aggregate the multiple sketches into a combined sketch. For example, the sketch handler circuitry 306 can determine if a given user has accessed the same media via multiple publishers (e.g., the publishers 102a, 102b, 102c) and remove duplicate accesses from the combined sketch. As such, the sketch handler circuitry 306 is able to accurately deduplicate user monitoring data within the combined sketch.

Although the sketch service 206 has access to the sketch data including sensitive user data in order to generate the deduplicated combined sketch, the publishers 102a, 102b, 102c have not agreed for the AME controller 202 located outside of the CCE 204 to have access to the sensitive user data. Therefore, the example sketch service 206 removes the sensitive user data from the deduplicated combined sketch prior to providing the combined sketch to the AME controller 202. As such, the example sketch handler circuitry 306 can generate an anonymized combined sketch. For example, after the sketch handler circuitry 306 aggregates the multiple sketches into a deduplicated combined sketch, the sketch handler circuitry 306 can anonymize the combined sketch. In some examples, the sketch handler circuitry 306 can anonymize the combined sketch by removing the portion of the combined sketch including the sensitive user data. In another example, the sketch handler circuitry 306 can anonymize the combined sketch by aggregating the sensitive user data into demographic categories. For example, the sketch handler circuitry 306 can aggregate the user monitoring data corresponding to all users within given demographics (e.g., ages 25-34, all males, North American users, etc.). In this example, the AME controller 202 can access aggregated user monitoring data for a given demographic without having sensitive user data.

In some examples, prior to providing the user monitoring data using sensitive user data to the sketch service 206, the publishers 102a, 102b, 102c will come to an agreement with the AME 106 (FIG. 1) regarding what user monitoring data is allowed to leave the sketch service 206 (e.g., the sketch service within the secure environment of the CCE 204). The example sketch service 206 also includes data transmitter circuitry 308. The example data transmitter circuitry 308 can send the anonymized combined sketch data to the AME controller 202. For example, the data transmitter circuitry 308 can send the portion of the combined sketch data including only the previously agreed upon user monitoring data to the AME controller 202.

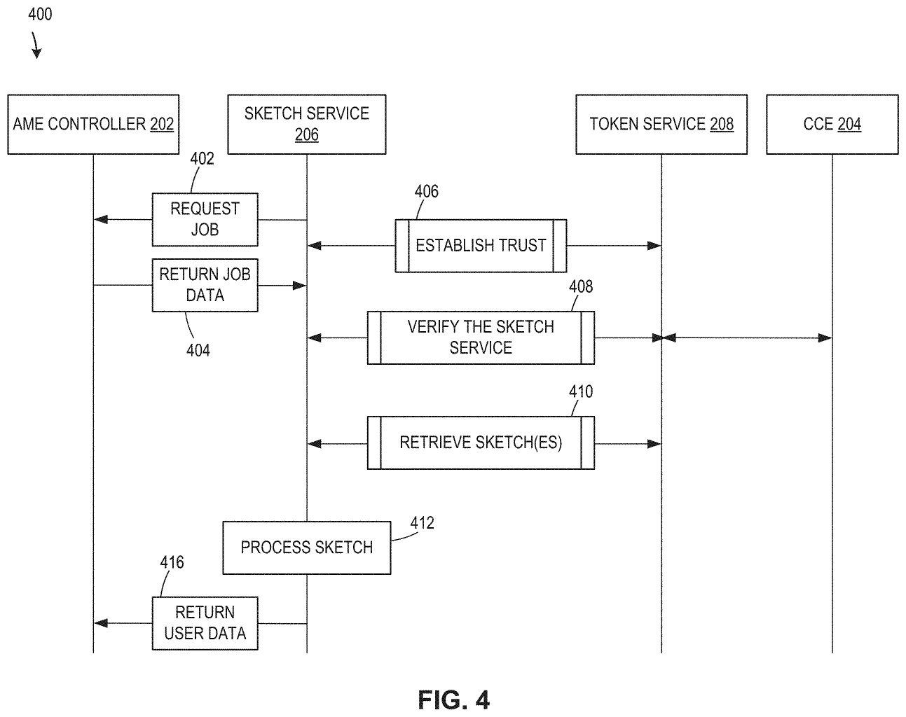

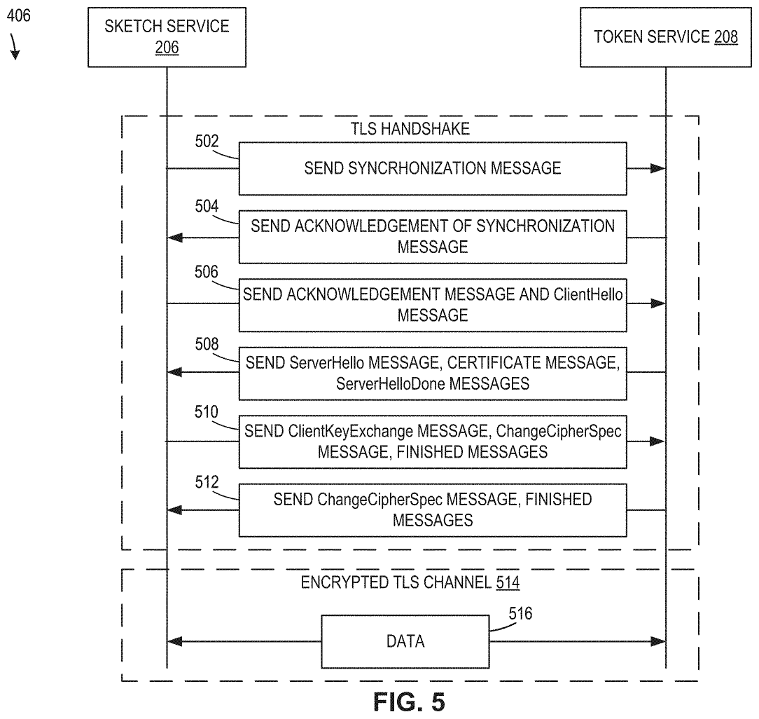

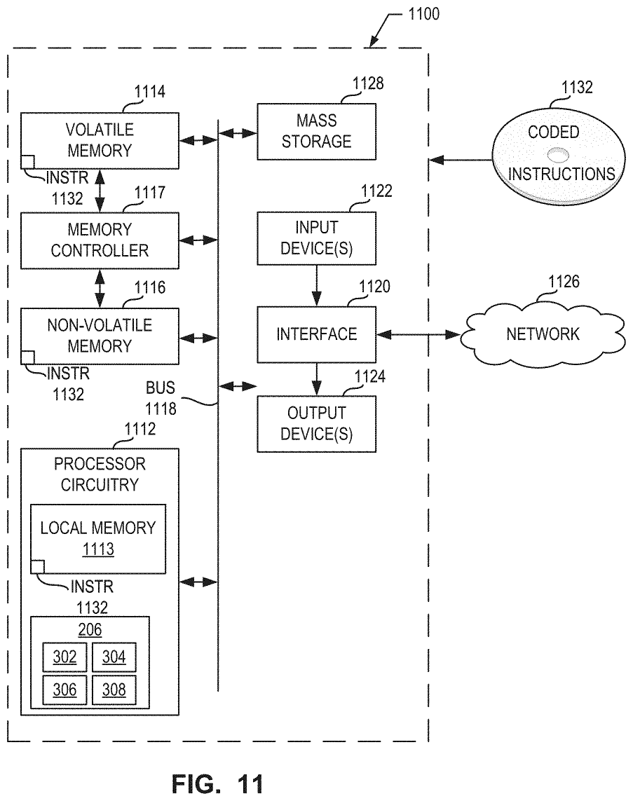

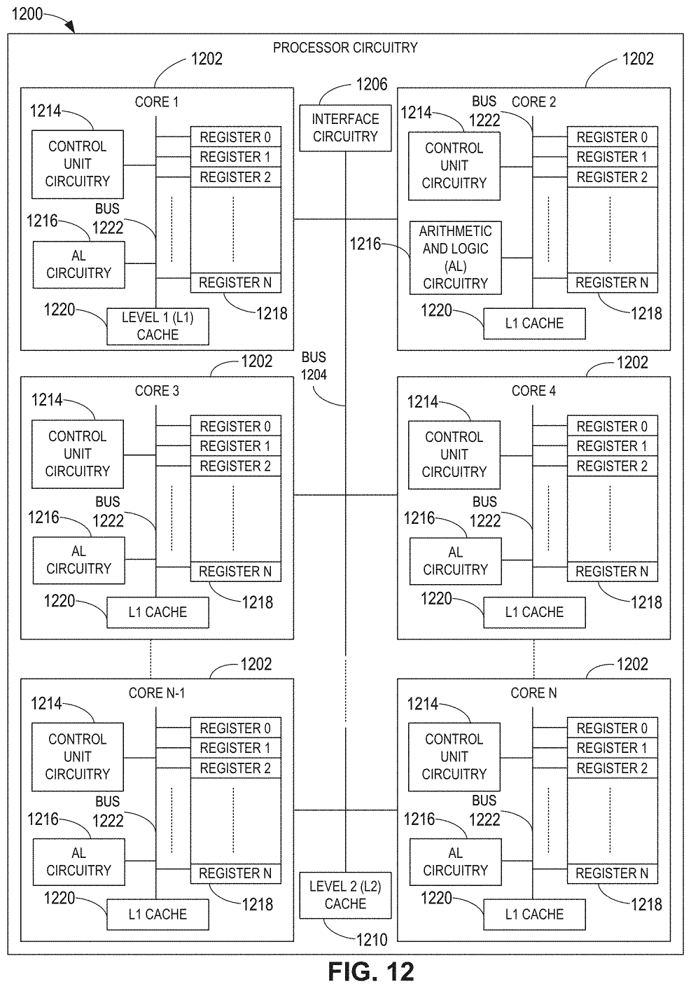

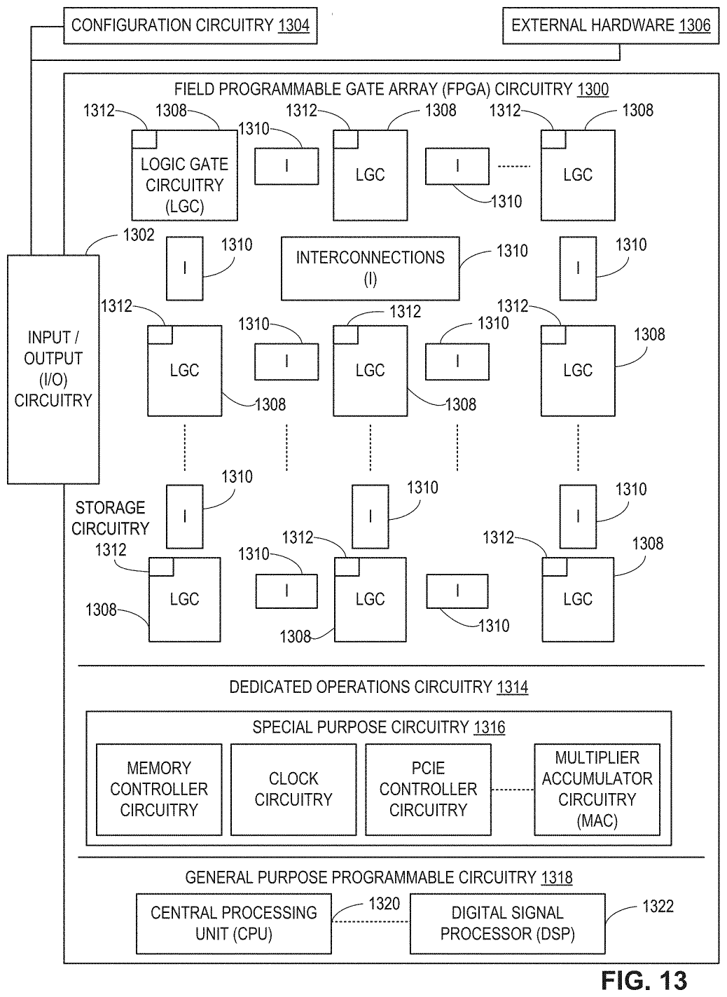

In some examples, the apparatus includes means for establishing trust with a publisher. For example, the means for establishing trust may be implemented by the token handler circuitry 304. In some examples, the token handler circuitry 304 may be instantiated by processor circuitry such as the example processor circuitry 1112 of FIG. 11. For instance, the token handler circuitry 304 may be instantiated by the example microprocessor 1200 of FIG. 12 executing machine executable instructions such as those implemented by at least blocks 406 of FIG. 4 and 502, 504, 506, 508, 510, 512 of FIG. 5. In some examples, the token handler circuitry 304 may be instantiated by hardware logic circuitry, which may be implemented by an ASIC, XPU, or the FPGA circuitry 1300 of FIG. 13 structured to perform operations corresponding to the machine readable instructions. Additionally or alternatively, the token handler circuitry 304 may be instantiated by any other combination of hardware, software, and/or firmware. For example, the token handler circuitry 304 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

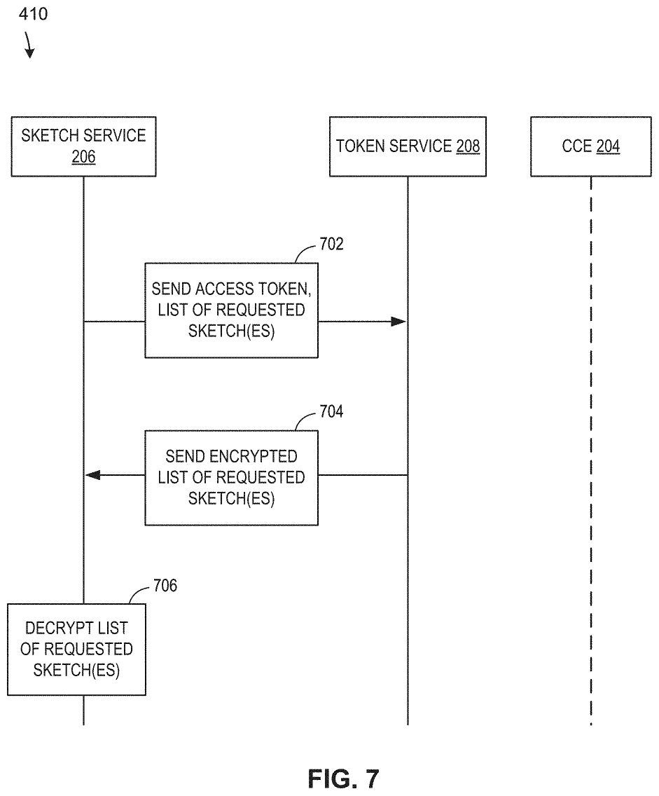

In some examples, the apparatus includes means for obtaining user monitoring data. For example, the means for obtaining user monitoring data may be implemented by the sketch handler circuitry 306. In some examples, the sketch handler circuitry 306 may be instantiated by processor circuitry such as the example processor circuitry 1112 of FIG. 11. For instance, the sketch handler circuitry 306 may be instantiated by the example microprocessor 1200 of FIG. 12 executing machine executable instructions such as those implemented by at least blocks 410 of FIG. 4 and 702, 704, 706 of FIG. 7. In some examples, the sketch handler circuitry 306 may be instantiated by hardware logic circuitry, which may be implemented by an ASIC, XPU, or the FPGA circuitry 1300 of FIG. 13 structured to perform operations corresponding to the machine readable instructions. Additionally or alternatively, the sketch handler circuitry 306 may be instantiated by any other combination of hardware, software, and/or firmware. For example, the sketch handler circuitry 306 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the apparatus includes means for processing user monitoring data. For example, the means for processing user monitoring data may be implemented by the sketch handler circuitry 306. In some examples, the sketch handler circuitry 306 may be instantiated by processor circuitry such as the example processor circuitry 1112 of FIG. 11. For instance, the sketch handler circuitry 306 may be instantiated by the example microprocessor 1200 of FIG. 12 executing machine executable instructions such as those implemented by at least blocks 412 of FIG. 4. In some examples, the sketch handler circuitry 306 may be instantiated by hardware logic circuitry, which may be implemented by an ASIC, XPU, or the FPGA circuitry 1300 of FIG. 13 structured to perform operations corresponding to the machine readable instructions. Additionally or alternatively, the sketch handler circuitry 306 may be instantiated by any other combination of hardware, software, and/or firmware. For example, the sketch handler circuitry 306 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the apparatus includes means for sending user monitoring data. For example, the means for sending user monitoring data may be implemented by the data transmitter circuitry 308. In some examples, the data transmitter circuitry 308 may be instantiated by processor circuitry such as the example processor circuitry 1112 of FIG. 11. For instance, the data transmitter circuitry 308 may be instantiated by the example microprocessor 1200 of FIG. 12 executing machine executable instructions such as those implemented by at least blocks 416 of FIG. 4. In some examples, the data transmitter circuitry 308 may be instantiated by hardware logic circuitry, which may be implemented by an ASIC, XPU, or the FPGA circuitry 1300 of FIG. 13 structured to perform operations corresponding to the machine readable instructions. Additionally or alternatively, the data transmitter circuitry 308 may be instantiated by any other combination of hardware, software, and/or firmware. For example, the data transmitter circuitry 308 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

While an example manner of implementing the sketch service 206 of FIG. 2 is illustrated in FIG. 3, one or more of the elements, processes, and/or devices illustrated in FIG. 3 may be combined, divided, re-arranged, omitted, eliminated, and/or implemented in any other way. Further, the example job interface circuitry 302, the example token handler circuitry 304, the example sketch handler circuitry 306, the example data transmitter circuitry 308, and/or, more generally, the example sketch service 206 of FIG. 2, may be implemented by hardware alone or by hardware in combination with software and/or firmware. Thus, for example, any of the example job interface circuitry 302, the example token handler circuitry 304, the example sketch handler circuitry 306, the example data transmitter circuitry 308, and/or, more generally, the example sketch service 206, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example sketch service 206 of FIG. 2 may include one or more elements, processes, and/or devices in addition to, or instead of, those illustrated in FIG. 3, and/or may include more than one of any or all of the illustrated elements, processes and devices.

Flowcharts representative of example hardware logic circuitry, machine readable instructions, hardware implemented state machines, and/or any combination thereof for implementing the sketch service 206 of FIGS. 1, 2, and/or 3 is shown in FIGS. 4-7. The machine readable instructions may be one or more executable programs or portion(s) of an executable program for execution by processor circuitry, such as the processor circuitry 1112 shown in the example processor platform 1100 discussed below in connection with FIG. 11 and/or the example processor circuitry discussed below in connection with FIGS. 12 and/or 13. The program may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program is described with reference to the flowcharts illustrated in FIGS. 4-7, many other methods of implementing the example sketch service 206 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU), etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 4-7 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium and non-transitory computer readable storage medium are expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

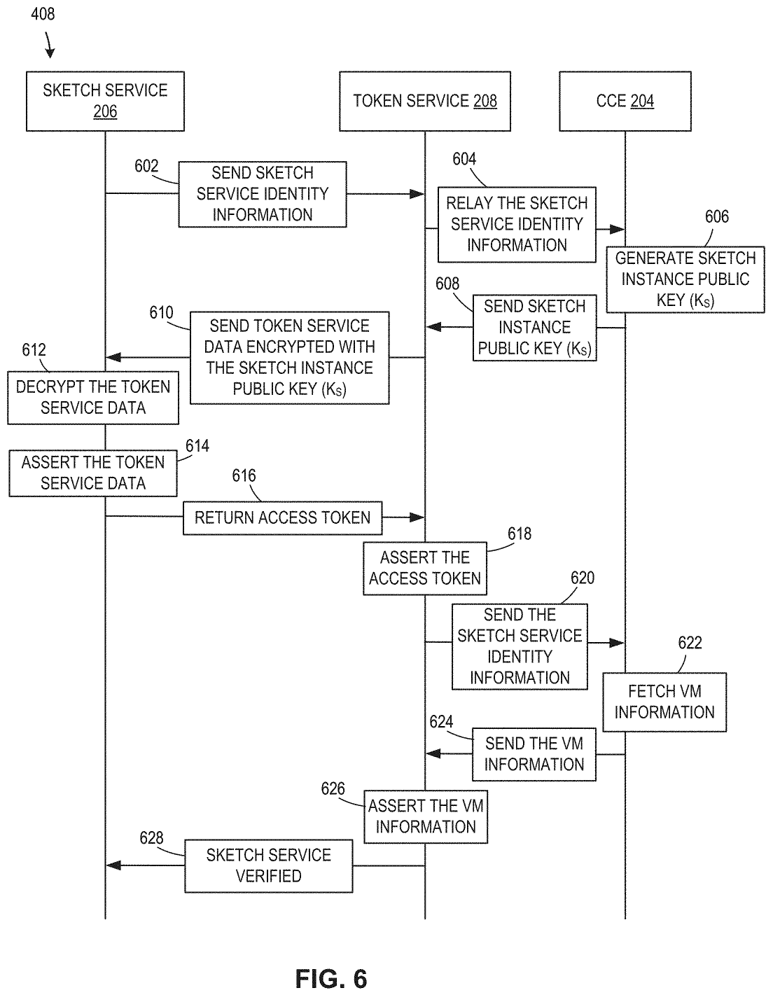

FIG. 4 is a flowchart representative of example machine readable instructions and/or example operations 400 that may be executed and/or instantiated by processor circuitry to perform confidential sketch processing. The machine readable instructions and/or the operations 300 of FIG. 3 begin at block 402 at which the example job interface circuitry 302 of the example sketch service 206 sends a request for job information to the AME controller 202. At block 404, the AME controller 202 returns job information regarding media for which user data should be collected and aggregated. At block 406, the example sketch service 206 establishes trust with the example token service 208. Example instructions that may be used to implement the trust establishment of block 406 are discussed below in conjunction with FIG. 5. At block 408, the example sketch service 206 is verified. The example sketch service 206, the example token service 208, and the example CCE 204 communicate to verify the sketch service 206. Example instructions that may be used to implement the verification of the sketch service of block 408 are discussed below in conjunction with FIG. 6. In some examples, the sketch service 206 is in communication with a plurality of token services 208 (e.g., the token services 208a, 208b, 208c of FIG. 2). In these examples, the processes of blocks 406 and 408 may be repeated with each of the example token services 208 with which the sketch service is in communication.

At block 410, the example sketch handler circuitry 306 of the sketch service 206 retrieves sketch data from the token service 208. Example instructions that may be used to implement the retrieval of the sketch data are discussed below in conjunction with FIG. 7. In some examples, the sketch service 206 retrieves sketch data from the plurality of token services 208 (e.g., the token services 208a, 208b, 208c of the publishers 102a, 102b, 102c of FIG. 2). In other examples, the sketch service 206 retrieves multiple sketches from the same token service 208. The example operations of block 410 may be repeated each time the example sketch service 206 is to retrieve sketch data. The one or more sketches received by the sketch service 206 at block 410 can include user monitoring data including sensitive user data. In some examples, the one or more sketches received by the sketch service 206 at block 410 are encrypted.

At block 412, the example sketch handler circuitry 306 of the sketch service 206 processes the received sketch data. For example, the sketch service 206 decrypts the sketch data. If the sketch service 206 has received more than one sketch, the sketch handler circuitry 306 can aggregate the sketch data into combined sketch data. The example sketch handler circuitry 306 can also anonymize the sketch data and/or the combined sketch data to remove the sensitive user data. Finally, at block 416, the example data transmitter circuitry 308 of the sketch service 206 returns user data to the AME controller 202. For example, the data transmitter circuitry 308 can send the anonymized combined sketch data to the AME controller 202. The process of FIG. 4 ends.

FIG. 5 is a flowchart representative of example machine readable instructions and/or example operations 406 that may be executed and/or instantiated by processor circuitry to establish trust with the token service 208 using a TLS handshake. The machine readable instructions and/or the operations 406 of FIG. 5 begin at block 502, at which the token handler circuitry 304 (FIG. 3) of the sketch service 206 sends a synchronization message to the token service 208. At block 504, the token service 208 sends an acknowledgement of the synchronization message to the token handler circuitry 304. At block 506, the token handler circuitry 304 sends an acknowledgement message and a ClientHello message to the token service 208. At block 508, the token service 208 sends a ServerHello message, a certificate message, and a ServerHelloDone message to the token handler circuitry 304. At block 510, the token handler circuitry 304 sends a ClientKeyExchance message, a ChangeCipherSpec message, and a finished message to the token service 208. At block 512, the token service 208 sends a ChangeCipherSpec message and a finished message back to the token handler circuitry 304 of the sketch service 206. Upon completion of the instructions of block 512, the TLS handshake is complete, thus establishing trust between the sketch service 206 and the token service 208. An encrypted TLS channel 514 is opened between the sketch service 206 and the token service 208 for the exchange of data 516 as shown in block 516.

FIG. 6 is a flowchart representative of example machine readable instructions and/or example operations 408 that may be executed and/or instantiated by processor circuitry to verify the sketch service 206. The machine readable instructions and/or the operations 408 of FIG. 6 begin at block 602, at which the token handler circuitry 304 (FIG. 3) of the sketch service 206 sends a communication containing identity information of the sketch service 206 to the example token service 208. When the sketch service 206 forms the connection with the token service 208 to send the identity information, the sketch service 206 records an initial FQDN of the token service 208. The encrypted TLS channel 514 (FIG. 5) is used for the communication of block 602 and all subsequent communications between the sketch service 206 and the token service 208. At block 604, the example token service 208 relays the identify information of the sketch service 206 to the CCE 204. At block 606, the example CCE 204 generates a public key (K_{S}) corresponding to the current instance of the sketch service 206. At block 608, the example CCE 204 sends the public key (K_{S}) corresponding to the current instance of the sketch service 206 to the token service 208.

At block 610, the example token service 208 sends a communication to the example token handler circuitry 304 of the sketch service 206 including data regarding the token service 208. For example, the data regarding the token service 208 can include a FQDN of the token service 208, an access token (τ), a timestamp, and/or any other data regarding the token service 208. In the example of FIG. 6, the data regarding the token service 208 is encrypted with the public key (K_{S}) corresponding to the current instance of the sketch service 206. At block 612, the example token handler circuitry 304 decrypts the data regarding the token service 208. For example, the token handler circuitry 304 can use a sketch service private key (X_{S}) to access the FQDN of the token service 208, the access token (τ), the timestamp, and/or any other data regarding the token service 208 included in the communication from the token service 208 at block 610.

At block 614, the example token handler circuitry 304 asserts (e.g., checks) the FQDN of the token service 208 received in the data regarding the token service 208 against the initial FDQN of the token service 208. For example, the token handler circuitry 304 compares the FQDN of the token service 208 to the initial FQDN of the token service 208. In the example of FIG. 6, both the FQDN of the token service 208 and the initial FQDN of the token service 208 are the same and assertion of the data regarding the token service 208 passes. An example where the FQDNs are not the same is described in connection with FIG. 10 below.

At block 616, the example token handler circuitry 304 of the sketch service 206 sends the access token (τ) back to the token service 208. At block 618, the token service 208 asserts the access token (τ) sent by the sketch service 206. Because only the sketch service 206 having the sketch service private key (X_{S}) can decrypt the data regarding the token service 208, the access token (τ) can be used by the token service 208 to assert the sketch service 206. In the example of FIG. 6, the assertion of the access token (τ) passes.

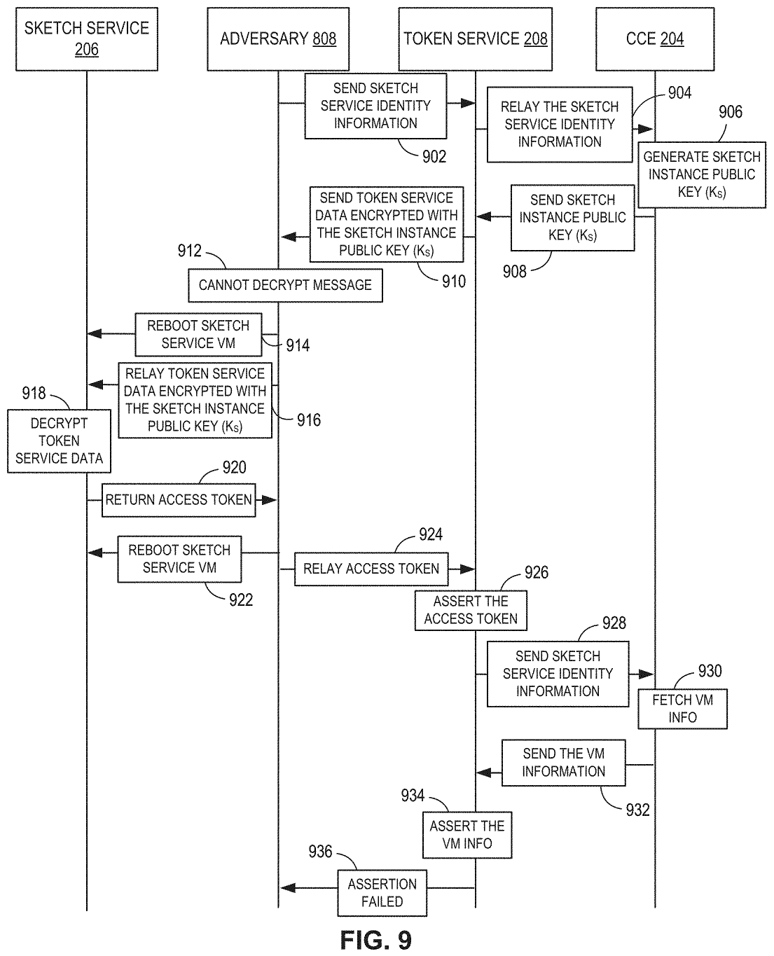

At block 620, the example token service 208 again sends the identity information of the sketch service 206 to the CCE 204 after the access token (τ) is asserted. In response to receiving the identify information of the sketch service 206, the CCE fetches Virtual Machine (VM) information for the VM corresponding to the sketch service 206 (block 622). For example, the VM information for the VM corresponding to the sketch service 206 includes a configuration report including a history of all runtime changes within the VM. The configuration report can include a full description of the VM configuration including, but not limited to, a base image, a bootstrap script (e.g., Cloudinit), binary checksums, network configurations, I/O resources (e.g., disks and/or network settings), and external executable programs configured (e.g., BIOS, bootstrap, initialization scripts, etc.). At block 624, the CCE 204 sends the VM information (e.g., the configuration report) to the token service 208. At block 626, the example token service 208 asserts the VM information. For example, the token service 208 asserts the base image, the bootstrap script, the binary checksums, the network configurations, the I/O resources, and/or the external executable programs configured on the VM. In the example of FIG. 6, the assertion of the VM information passes. An example where the assertion of the VM information does not pass is described in connection with FIG. 9 below. In response to the assertion of the VM information at block 626, the sketch service 206 is verified (block 628).

FIG. 7 is a flowchart representative of example machine readable instructions and/or example operations 410 that may be executed and/or instantiated by processor circuitry to retrieve sketch data. The machine readable instructions and/or the operations 410 of FIG. 7 begin at block 702, at which the example sketch handler circuitry 306 of the sketch service 206 sends a communication to the token service 208 containing the access token (τ) and a list of requested sketch data. In some examples, the access token (τ) is the access token received during the verification of the sketch service 206 (block 610 of FIG. 6). At block 704, the example token service 208 responds by sending a communication back to the sketch handler circuitry 306 of the sketch service 206 containing the requested sketch data. In some examples, the requested sketch data including sensitive user information is encrypted with the public key (K_{S}) corresponding to the current instance of the sketch service 206. At block 706, the example sketch handler circuitry 306 of the sketch service 206 decrypts the sketch data. For example, the sketch handler circuitry 306 decrypts the sketch data including sensitive user information using a sketch service private key (X_{S}).

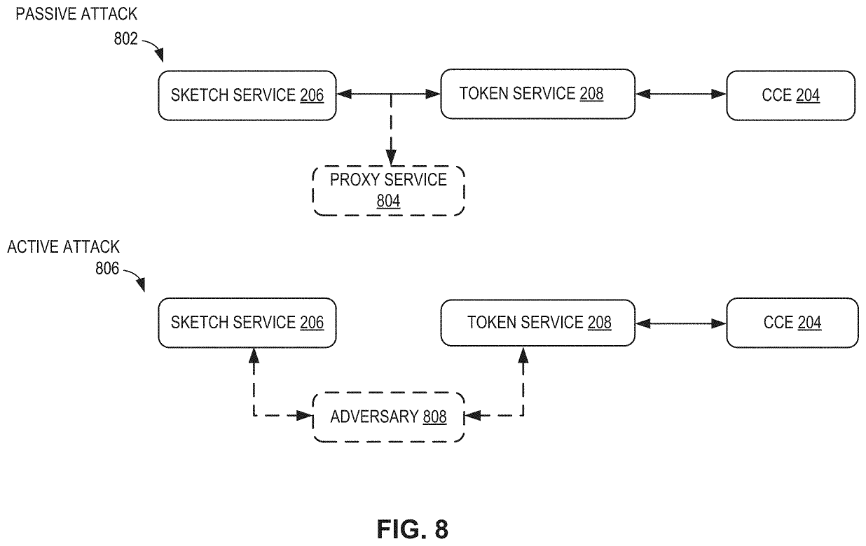

FIG. 8 is a block diagram illustrating example attacks which may be attempted on the example sketch processing system. Example security protocols disclosed herein protect from both passive attacks and active attacks. In an example passive attack 802, an example proxy service 804 attempts to capture traffic (e.g., sketch data including sensitive user data) between the example sketch service 206 and the example token service 208 as shown in FIG. 8. Because the traffic (e.g., the sketch data including sensitive user data) between the sketch service 206 and the token service 208 is sent within the encrypted TLS channel 514 (FIG. 5), the example proxy service 804 cannot decrypt the TLS encrypted traffic and the sensitive user data is protected.

Additionally, in order to intercept traffic within the encrypted TLS channel 514, the proxy service 804 must terminate the connection with a first side (e.g., the sketch service 206) of the connection and initiate a connection with a second side (e.g., the token service 208) of the connection. The termination must be done in cooperation with the first side (e.g., the sketch service 206) by installing the proxy service 804 on the first side (e.g., the sketch service 206). Modifications to the sketch service 206 by the proxy service 804 will be detected by the example token service 208 in the bootstrap script or shared source code using the protocol disclosed herein thus protecting the sketch data including sensitive user information from the attack. Additionally or alternatively, the sketch data including sensitive user data may be encrypted using a public key corresponding to the sketch service 206. Because the proxy service 804 does not have access to the private key corresponding to the sketch service 206, the proxy service 804 cannot decrypt the sketch data and the sensitive user data is protected.

In a first example active attack 806, an adversary 808 attempts to impersonate the sketch service 206. For example, the adversary 808 can attempt a direct connection with the token service 208 in order to obtain the access token (τ). Such an example active attack 806 is discussed below in connection with FIG. 9. In another example of an active attack 806, the adversary 808 attempts to impersonate the token service 208 in order to attempt to obtain the access token (τ). Such an example active attack 806 is discussed below in connection with FIG. 10. For example, the adversary 808 impersonating the token service 208 may pass encrypted traffic from the token service 208 to the sketch service 206. However, example security protocols disclosed herein can detect the adversary 808 during assertion of the FQDN of the token service 208.

FIG. 9 is a flowchart illustrating an example active attack which may be attempted on the example system. In the example of FIG. 9, the adversary 808 attempts to impersonate the sketch service 206. At block 902, while impersonating the sketch service 206, the example adversary 808 sends identity information of the sketch service 206 to the example token service. At block 904, the example token service 208 relays the identify information of the sketch service 206 to the CCE 204. At block 906, the example CCE 204 generates a public key (K_{S}) corresponding to the current instance of the sketch service 206. At block 908, the example CCE 204 sends the public key (K_{S}) corresponding to the current instance of the sketch service 206 to the token service 208. At block 910, the example token service 208 sends a communication to the adversary 808 including data regarding the token service 208. For example, the data regarding the token service 208 can include a FQDN of the token service 208, an access token (τ), a timestamp, and/or any other data regarding the token service 208. In the example of FIG. 9, the data regarding the token service 208 is encrypted with the public key (K_{S}) corresponding to the current instance of the sketch service 206.

At block 912, the example adversary 808 attempts to decrypt the data regarding the token service 208. However, because the adversary 808 does not have access to the private key corresponding to the sketch service 206, the adversary 808 cannot decrypt the data. At block 914, the adversary 808 reboots the VM that the sketch service 206 is running on to gain temporary access to the VM. At block 916, the adversary 808 relays the data regarding the token service 208 encrypted with the public key (K_{S}) to the sketch service 206. The example sketch service 206 receives and decrypts the data regarding the token service 208 using the sketch service private key (X_{S}) (block 918). At block 920, the sketch service 206 sends the decrypted access token to the adversary 808. For example, the sketch service 206 may believe that the entity that sent the data regarding the token service 208 is the token service 208 and sends the access token back to the entity in an attempt to verify the sketch service 206. However, in the example of FIG. 9, the entity that sent the data regarding the token service 208 is the adversary 808. Therefore, the sketch service 206 sends the access token to the adversary 808.

At block 922, the example adversary reboots the VM that the sketch service 206 is running on to remove the temporary access of the adversary 808. Although the sketch service 206 is returned to its original state, each time the VM that the sketch service 206 is running on is rebooted (e.g., at blocks 914 and/or 922), the reboot is recorded in the configuration of the VM. At block 924, the adversary 808 relays the access token to the token service 208 and the token service 208 checks (e.g., asserts) the access token (block 926). In the example of FIG. 9, the assertion passes, and the token service 208 once again sends the identity information of the sketch service 206 to the CCE 204 (block 928). At block 930, the CCE 204 fetches VM information for the VM corresponding to the sketch service 206. For example, the VM information for the VM corresponding to the sketch service 206 includes a configuration report including a history of all runtime changes within the VM. At block 932, the CCE 204 sends the VM information (e.g., the configuration report) to the token service 208. At block 934, the example token service 208 asserts the VM information. However, because the VM has been rebooted, the assertion of the VM information fails (block 936).

FIG. 10 is a flowchart illustrating an example attack which may be attempted on the example system. In the example attack of FIG. 10, the example adversary 808 impersonates the token service 208. As such, believing the adversary 808 to be the token service 208, the token handler circuitry 304 (FIG. 3) of the sketch service 206 sends a communication containing identity information of the sketch service 206 to the example adversary 808 (block 1002). When the sketch service 206 forms the connection with an entity to send the identity information, the sketch service 206 records an initial FQDN of the entity. In the example of FIG. 10, the initial FQDN recorded by the sketch service 206 is an FQDN of the adversary 808. At block 1004, the example adversary 808 relays the identity information of the sketch service 206 to the token service and at block 1006, the example token service 208 relays the identify information of the sketch service 206 to the CCE 204. At block 1008, the example CCE 204 generates a public key (K_{S}) corresponding to the current instance of the sketch service 206. At block 1010, the example CCE 204 sends the public key (K_{S}) corresponding to the current instance of the sketch service 206 to the token service 208.

At block 1012, the example token service 208 sends a communication to the example adversary 808 including data regarding the token service 208. For example, the data regarding the token service 208 can include a FQDN of the token service 208, an access token (τ), a timestamp, and/or any other data regarding the token service 208. In the example of FIG. 10, the data regarding the token service 208 is encrypted with the public key (K_{S}) corresponding to the current instance of the sketch service 206. Because the example adversary 808 cannot decrypt the data regarding the token service 208, the example adversary 808 relays the data regarding the token service 208 to the example token handler circuitry 304 of the sketch service 206 (block 1014). At block 1016, the example token handler circuitry 304 decrypts the data regarding the token service 208. For example, the token handler circuitry 304 can use a sketch service private key (X_{S}) to access the FQDN of the token service 208, the access token (τ), the timestamp, and/or any other data regarding the token service 208 included in the communication from the token service 208 at block 610.

At block 1018, the example token handler circuitry 304 asserts (e.g., checks) the FQDN of the token service 208 received in the data regarding the token service 208 against the initial FDQN of the entity with which the sketch service 206 initially connected. For example, the token handler circuitry 304 compares the FQDN of the token service 208 received in the data regarding the token service 208 to the FQDN of the entity to which the sketch service 206 connected to send the identity information of the sketch service 206. In the example of FIG. 10, the entity to which the sketch service 206 connected to send the identity information of the sketch service 206 was the example adversary 808 and the FDQN recorded at that step was the FDQN of the adversary 808. Therefore, the initial FQDN and the FQDN of the token service 208 as received in the data regarding the token service 208 do not match and the assertion fails (block 1020).

FIG. 11 is a block diagram of an example processor platform 1100 structured to execute and/or instantiate the machine readable instructions and/or the operations of FIGS. 4-7 to implement the sketch service of FIG. 3. The processor platform 1100 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 1100 of the illustrated example includes processor circuitry 1112. The processor circuitry 1112 of the illustrated example is hardware. For example, the processor circuitry 1112 can be implemented by one or more integrated circuits, logic circuits, FPGAs, microprocessors, CPUs, GPUs, DSPs, and/or microcontrollers from any desired family or manufacturer. The processor circuitry 1112 may be implemented by one or more semiconductor based (e.g., silicon based) devices. In this example, the processor circuitry 1112 implements the sketch service 206, the job interface circuitry 302, the token handler circuitry 304, the sketch handler circuitry 306, and the data transmitter circuitry 308.

The processor circuitry 1112 of the illustrated example includes a local memory 1113 (e.g., a cache, registers, etc.). The processor circuitry 1112 of the illustrated example is in communication with a main memory including a volatile memory 1114 and a non-volatile memory 1116 by a bus 1118. The volatile memory 1114 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1116 may be implemented by flash memory and/or any other desired type of memory device. Access to the main memory 1114, 1116 of the illustrated example is controlled by a memory controller 1117.

The processor platform 1100 of the illustrated example also includes interface circuitry 1120. The interface circuitry 1120 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1122 are connected to the interface circuitry 1120. The input device(s) 1122 permit(s) a user to enter data and/or commands into the processor circuitry 1112. The input device(s) 1122 can be implemented by, for example, an audio sensor, a microphone, a camera (still or video), a keyboard, a button, a mouse, a touchscreen, a track-pad, a trackball, an isopoint device, and/or a voice recognition system.

One or more output devices 1124 are also connected to the interface circuitry 1120 of the illustrated example. The output device(s) 1124 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1120 of the illustrated example, thus, typically includes a graphics driver card, a graphics driver chip, and/or graphics processor circuitry such as a GPU.

The interface circuitry 1120 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1126. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 1100 of the illustrated example also includes one or more mass storage devices 1128 to store software and/or data. Examples of such mass storage devices 1128 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives.

The machine executable instructions 1132, which may be implemented by the machine readable instructions of FIGS. 4-7, may be stored in the mass storage device 1128, in the volatile memory 1114, in the non-volatile memory 1116, and/or on a removable non-transitory computer readable storage medium such as a CD or DVD.

FIG. 12 is a block diagram of an example implementation of the processor circuitry 1112 of FIG. 11. In this example, the processor circuitry 1112 of FIG. 11 is implemented by a microprocessor 1200. For example, the microprocessor 1200 may be a general purpose microprocessor (e.g., general purpose microprocessor circuitry). The microprocessor 1200 executes some or all of the machine readable instructions of the flowcharts of FIGS. 4-7 to effectively instantiate the sketch service 206 of FIG. 3 as logic circuits to perform the operations corresponding to those machine readable instructions. In some such examples, the circuitry of FIG. 3 is instantiated by the hardware circuits of the microprocessor 1200 in combination with the instructions. For example, the microprocessor 1200 may be implemented by multi-core hardware circuitry such as a CPU, a DSP, a GPU, an XPU, etc. Although it may include any number of example cores 1202 (e.g., 1 core), the microprocessor 1200 of this example is a multi-core semiconductor device including N cores. The cores 1202 of the microprocessor 1200 may operate independently or may cooperate to execute machine readable instructions. For example, machine code corresponding to a firmware program, an embedded software program, or a software program may be executed by one of the cores 1202 or may be executed by multiple ones of the cores 1202 at the same or different times. In some examples, the machine code corresponding to the firmware program, the embedded software program, or the software program is split into threads and executed in parallel by two or more of the cores 1202. The software program may correspond to a portion or all of the machine readable instructions and/or operations represented by the flowcharts of FIGS. 4-7.

The cores 1202 may communicate by a first example bus 1204. In some examples, the first bus 1204 may be implemented by a communication bus to effectuate communication associated with one(s) of the cores 1202. For example, the first bus 1204 may be implemented by at least one of an Inter-Integrated Circuit (I2C) bus, a Serial Peripheral Interface (SPI) bus, a PCI bus, or a PCIe bus. Additionally or alternatively, the first bus 1204 may be implemented by any other type of computing or electrical bus. The cores 1202 may obtain data, instructions, and/or signals from one or more external devices by example interface circuitry 1206. The cores 1202 may output data, instructions, and/or signals to the one or more external devices by the interface circuitry 1206. Although the cores 1202 of this example include example local memory 1220 (e.g., Level 1 (L1) cache that may be split into an L1 data cache and an L1 instruction cache), the microprocessor 1200 also includes example shared memory 1210 that may be shared by the cores (e.g., Level 2 (L2_cache)) for high-speed access to data and/or instructions. Data and/or instructions may be transferred (e.g., shared) by writing to and/or reading from the shared memory 1210. The local memory 1220 of each of the cores 1202 and the shared memory 1210 may be part of a hierarchy of storage devices including multiple levels of cache memory and the main memory (e.g., the main memory 1114, 1116 of FIG. 11). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1202 may be referred to as a CPU, DSP, GPU, etc., or any other type of hardware circuitry. Each core 1202 includes control unit circuitry 1214, arithmetic and logic (AL) circuitry (sometimes referred to as an ALU) 1216, a plurality of registers 1218, the local memory 1220, and a second example bus 1222. Other structures may be present. For example, each core 1202 may include vector unit circuitry, single instruction multiple data (SIMD) unit circuitry, load/store unit (LSU) circuitry, branch/jump unit circuitry, floating-point unit (FPU) circuitry, etc. The control unit circuitry 1214 includes semiconductor-based circuits structured to control (e.g., coordinate) data movement within the corresponding core 1202. The AL circuitry 1216 includes semiconductor-based circuits structured to perform one or more mathematic and/or logic operations on the data within the corresponding core 1202. The AL circuitry 1216 of some examples performs integer based operations. In other examples, the AL circuitry 1216 also performs floating point operations. In yet other examples, the AL circuitry 1216 may include first AL circuitry that performs integer based operations and second AL circuitry that performs floating point operations. In some examples, the AL circuitry 1216 may be referred to as an Arithmetic Logic Unit (ALU). The registers 1218 are semiconductor-based structures to store data and/or instructions such as results of one or more of the operations performed by the AL circuitry 1216 of the corresponding core 1202. For example, the registers 1218 may include vector register(s), SIMD register(s), general purpose register(s), flag register(s), segment register(s), machine specific register(s), instruction pointer register(s), control register(s), debug register(s), memory management register(s), machine check register(s), etc. The registers 1218 may be arranged in a bank as shown in FIG. 12. Alternatively, the registers 1218 may be organized in any other arrangement, format, or structure including distributed throughout the core 1202 to shorten access time. The second bus 1222 may be implemented by at least one of an I2C bus, a SPI bus, a PCI bus, or a PCIe bus.

Each core 1202 and/or, more generally, the microprocessor 1200 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1200 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

FIG. 13 is a block diagram of another example implementation of the processor circuitry 1112 of FIG. 11. In this example, the processor circuitry 1112 is implemented by FPGA circuitry 1300. For example, the FPGA circuitry 1300 may be implemented by an FPGA. The FPGA circuitry 1300 can be used, for example, to perform operations that could otherwise be performed by the example microprocessor 1200 of FIG. 12 executing corresponding machine readable instructions. However, once configured, the FPGA circuitry 1300 instantiates the machine readable instructions in hardware and, thus, can often execute the operations faster than they could be performed by a general purpose microprocessor executing the corresponding software.

More specifically, in contrast to the microprocessor 1200 of FIG. 12 described above (which is a general purpose device that may be programmed to execute some or all of the machine readable instructions represented by the flowcharts of FIGS. 4-7 but whose interconnections and logic circuitry are fixed once fabricated), the FPGA circuitry 1300 of the example of FIG. 13 includes interconnections and logic circuitry that may be configured and/or interconnected in different ways after fabrication to instantiate, for example, some or all of the machine readable instructions represented by the flowcharts of FIGS. 4-7. In particular, the FPGA circuitry 1300 may be thought of as an array of logic gates, interconnections, and switches. The switches can be programmed to change how the logic gates are interconnected by the interconnections, effectively forming one or more dedicated logic circuits (unless and until the FPGA circuitry 1300 is reprogrammed). The configured logic circuits enable the logic gates to cooperate in different ways to perform different operations on data received by input circuitry. Those operations may correspond to some or all of the software represented by the flowcharts of FIGS. 4-7. As such, the FPGA circuitry 1300 may be structured to effectively instantiate some or all of the machine readable instructions of the flowcharts of FIGS. 4-7 as dedicated logic circuits to perform the operations corresponding to those software instructions in a dedicated manner analogous to an ASIC. Therefore, the FPGA circuitry 1300 may perform the operations corresponding to the some or all of the machine readable instructions of FIGS. 4-7 faster than the general purpose microprocessor can execute the same.

In the example of FIG. 13, the FPGA circuitry 1300 is structured to be programmed (and/or reprogrammed one or more times) by an end user by a hardware description language (HDL) such as Verilog. The FPGA circuitry 1300 of FIG. 13, includes example input/output (I/O) circuitry 1302 to obtain and/or output data to/from example configuration circuitry 1304 and/or external hardware 1306. For example, the configuration circuitry 1304 may be implemented by interface circuitry that may obtain machine readable instructions to configure the FPGA circuitry 1300, or portion(s) thereof. In some such examples, the configuration circuitry 1304 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 1306 may be implemented by external hardware circuitry. For example, the external hardware 1306 may be implemented by the microprocessor 1200 of FIG. 12. The FPGA circuitry 1300 also includes an array of example logic gate circuitry 1308, a plurality of example configurable interconnections 1310, and example storage circuitry 1312. The logic gate circuitry 1308 and the configurable interconnections 1310 are configurable to instantiate one or more operations that may correspond to at least some of the machine readable instructions of FIGS. 4-7 and/or other desired operations. The logic gate circuitry 1308 shown in FIG. 13 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1308 to enable configuration of the electrical structures and/or the logic gates to form circuits to perform desired operations. The logic gate circuitry 1308 may include other electrical structures such as look-up tables (LUTs), registers (e.g., flip-flops or latches), multiplexers, etc.

The configurable interconnections 1310 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1308 to program desired logic circuits.

The storage circuitry 1312 of the illustrated example is structured to store result(s) of the one or more of the operations performed by corresponding logic gates. The storage circuitry 1312 may be implemented by registers or the like. In the illustrated example, the storage circuitry 1312 is distributed amongst the logic gate circuitry 1308 to facilitate access and increase execution speed.

The example FPGA circuitry 1300 of FIG. 13 also includes example Dedicated Operations Circuitry 1314. In this example, the Dedicated Operations Circuitry 1314 includes special purpose circuitry 1316 that may be invoked to implement commonly used functions to avoid the need to program those functions in the field. Examples of such special purpose circuitry 1316 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1300 may also include example general purpose programmable circuitry 1318 such as an example CPU 1320 and/or an example DSP 1322. Other general purpose programmable circuitry 1318 may additionally or alternatively be present such as a GPU, an XPU, etc., that can be programmed to perform other operations.

Although FIGS. 12 and 13 illustrate two example implementations of the processor circuitry 1112 of FIG. 11, many other approaches are contemplated. For example, as mentioned above, modern FPGA circuitry may include an on-board CPU, such as one or more of the example CPU 1320 of FIG. 13. Therefore, the processor circuitry 1112 of FIG. 11 may additionally be implemented by combining the example microprocessor 1200 of FIG. 12 and the example FPGA circuitry 1300 of FIG. 13. In some such hybrid examples, a first portion of the machine readable instructions represented by the flowcharts of FIGS. 4-7 may be executed by one or more of the cores 1202 of FIG. 12, a second portion of the machine readable instructions represented by the flowcharts of FIGS. 4-7 may be executed by the FPGA circuitry 1300 of FIG. 13, and/or a third portion of the machine readable instructions represented by the flowcharts of FIGS. 4-7 may be executed by an ASIC. It should be understood that some or all of the circuitry of FIG. 3 may, thus, be instantiated at the same or different times. Some or all of the circuitry may be instantiated, for example, in one or more threads executing concurrently and/or in series. Moreover, in some examples, some or all of the circuitry of FIG. 3 may be implemented within one or more virtual machines and/or containers executing on the microprocessor.

In some examples, the processor circuitry 1112 of FIG. 11 may be in one or more packages. For example, the microprocessor 1200 of FIG. 12 and/or the FPGA circuitry 1300 of FIG. 13 may be in one or more packages. In some examples, an XPU may be implemented by the processor circuitry 1112 of FIG. 11, which may be in one or more packages. For example, the XPU may include a CPU in one package, a DSP in another package, a GPU in yet another package, and an FPGA in still yet another package.

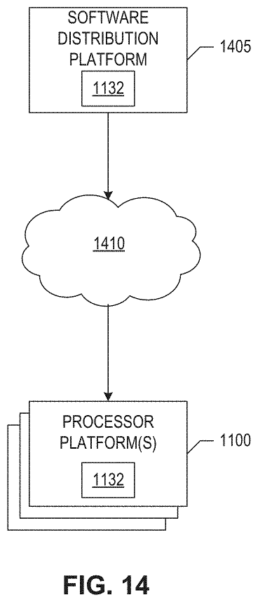

A block diagram illustrating an example software distribution platform 1405 to distribute software such as the example machine readable instructions 1132 of FIG. 11 to hardware devices owned and/or operated by third parties is illustrated in FIG. 14. The example software distribution platform 1405 may be implemented by any computer server, data facility, cloud service, etc., capable of storing and transmitting software to other computing devices. The third parties may be customers of the entity owning and/or operating the software distribution platform 1405. For example, the entity that owns and/or operates the software distribution platform 1405 may be a developer, a seller, and/or a licensor of software such as the example machine readable instructions 1132 of FIG. 11. The third parties may be consumers, users, retailers, OEMs, etc., who purchase and/or license the software for use and/or re-sale and/or sub-licensing. In the illustrated example, the software distribution platform 1405 includes one or more servers and one or more storage devices. The storage devices store the machine readable instructions 1132, which may correspond to the example machine readable instructions 400, 406, 408, 410 of FIGS. 4-7, as described above. The one or more servers of the example software distribution platform 1405 are in communication with a network 1410, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 1132 from the software distribution platform 1405. For example, the software, which may correspond to the example machine readable instructions 400, 406, 408, 410 of FIGS. 4-7, may be downloaded to the example processor platform 1100, which is to execute the machine readable instructions 1132 to implement the sketch service 206. In some examples, one or more servers of the software distribution platform 1405 periodically offer, transmit, and/or force updates to the software (e.g., the example machine readable instructions 1132 of FIG. 11) to ensure improvements, patches, updates, etc., are distributed and applied to the software at the end user devices.

From the foregoing, it will be appreciated that example systems, methods, apparatus, and articles of manufacture have been disclosed that provide for confidential processing of sketch data including sensitive user data. Disclosed systems, methods, apparatus, and articles of manufacture improve the efficiency of using a computing device by reducing processing resources needed to combine sketch data. By using examples disclosed herein, an audience measurement entity can have access to audience measurement data including sensitive user data. The audience measurement data including sensitive user data can be processed and combined using simpler methods than combining audience measurement data without sensitive user data. For example, multiple sketches including sensitive user data can be combined using simple additive methods whereas multiple sketches not including sensitive user data may require an iterative process to extract monitoring data by media item and/or demographic group prior to combining. Further, the combined sketch data may have improved accuracy due to the inclusion of the sensitive user data. Disclosed systems, methods, apparatus, and articles of manufacture are accordingly directed to one or more improvement(s) in the operation of a machine such as a computer or other electronic and/or mechanical device.

Example methods, apparatus, systems, and articles of manufacture for confidential sketch processing are disclosed herein. Further examples and combinations thereof include the following:

Example 1 includes an apparatus comprising token handler circuitry to establish trust with a publisher, sketch handler circuitry to obtain user monitoring data from the publisher, and process the user monitoring data, and data transmitter circuitry to send a portion of the processed user monitoring data to an audience measurement entity controller.

Example 2 includes the apparatus of example 1, wherein the token handler circuitry is to establish trust with the publisher using a transport layer security (TLS) handshake.

Example 3 includes the apparatus of example 1, wherein the sketch handler circuitry is to obtain the user monitoring data in response to verification of the sketch handler circuitry.

Example 4 includes the apparatus of example 3, wherein the verification of the sketch handler circuitry includes the token handler circuitry to record a connection fully qualified domain name (FQDN) of the publisher during connection to the publisher.

Example 5 includes the apparatus of example 4, wherein the verification of the sketch handler circuitry includes the token handler circuitry to assert a retrieved FQDN of the publisher against the connection FQDN of the publisher.

Example 6 includes the apparatus of example 1, wherein the sketch handler circuitry is to obtain the user monitoring data from the publisher by sending a request to the publisher including an access token.

Example 7 includes the apparatus of example 1, wherein the sketch handler circuitry is to obtain the user monitoring data from the publisher by obtaining encrypted user monitoring data from the publisher, and decrypting the encrypted user monitoring data.

Example 8 includes the apparatus of example 1, wherein the sketch handler circuitry is to obtain second user monitoring data from a second publisher.

Example 9 includes the apparatus of example 8, wherein the sketch handler circuitry is to process the user monitoring data by aggregating the user monitoring data with the second user monitoring data.

Example 10 includes at least one non-transitory computer readable storage medium comprising instructions that, when executed, cause at least one processor to establish trust with a publisher, obtain user monitoring data from the publisher, process the user monitoring data, and send a portion of the processed user monitoring data to an audience measurement entity controller.

Example 11 includes the at least one non-transitory computer readable storage medium of example 10, wherein the instructions cause the at least one processor to establish trust with the publisher using a transport layer security (TLS) handshake.

Example 12 includes the at least one non-transitory computer readable storage medium of example 10, wherein the instructions cause the at least one processor to obtain the user monitoring data in response to verification of the at least one non-transitory computer readable storage medium.

Example 13 includes the at least one non-transitory computer readable storage medium of example 12, wherein the verification of the at least one non-transitory computer readable storage medium includes the instructions to cause the at least one processor to record a connection fully qualified domain name (FQDN) of the publisher during connection to the publisher.

Example 14 includes the at least one non-transitory computer readable storage medium of example 13, wherein the verification of the at least one non-transitory computer readable storage medium includes the instructions to cause the at least one processor to assert a retrieved FQDN of the publisher against the connection FQDN of the publisher.

Example 15 includes the at least one non-transitory computer readable storage medium of example 10, wherein the instructions are to cause the at least one processor to obtain the user monitoring data from the publisher by sending a request to the publisher including an access token.

Example 16 includes the at least one non-transitory computer readable storage medium of example 10, wherein the instructions are to cause the at least one processor to obtain the user monitoring data from the publisher by obtaining encrypted user monitoring data from the publisher, and decrypting the encrypted user monitoring data.

Example 17 includes the at least one non-transitory computer readable storage medium of example 10, wherein the instructions are to cause the at least one processor to obtain second user monitoring data from a second publisher.

Example 18 includes the at least one non-transitory computer readable storage medium of example 17, wherein the instructions are to cause the at least one processor to process of the user monitoring data by aggregating the user monitoring data with the second user monitoring data.

Example 19 includes a method, comprising establishing, by executing instructions with at least one processor, trust with a publisher, obtaining, by executing instructions with the at least one processor, user monitoring data from the publisher, processing, by executing instructions with the at least one processor, the user monitoring data, and sending, by executing instructions with the at least one processor, a portion of the processed user monitoring data to an audience measurement entity controller.

Example 20 includes the method of example 19, further including establishing trust with the publisher using a transport layer security (TLS) handshake.

Example 21 includes the method of example 19, further including obtaining the user monitoring data in response to verification of the at least one processor.

Example 22 includes the method of example 21, wherein the verification of the at least one processor includes recording a connection fully qualified domain name (FQDN) of the publisher during connection to the publisher.

Example 23 includes the method of example 22, wherein the verification of the at least one processor includes asserting a retrieved FQDN of the publisher against the connection FQDN of the publisher.

Example 24 includes the method of example 19, further including obtaining the user monitoring data from the publisher by sending a request to the publisher including an access token.

Example 25 includes the method of example 19, further including obtaining the user monitoring data from the publisher by obtaining encrypted user monitoring data from the publisher, and decrypting the encrypted user monitoring data.

Example 26 includes the method of example 19, further including obtaining second user monitoring data from a second publisher.

Example 27 includes the method of example 26, further including processing of the user monitoring data by aggregating the user monitoring data with the second user monitoring data.

Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

1. An apparatus comprising:
token handler circuitry to establish trust with a publisher;
sketch handler circuitry to:
obtain user monitoring data from the publisher; and
process the user monitoring data; and
data transmitter circuitry to send a portion of the processed user monitoring data to an audience measurement entity controller.

2. The apparatus of claim 1, wherein the token handler circuitry is to establish trust with the publisher using a transport layer security (TLS) handshake.

3. The apparatus of claim 1, wherein the sketch handler circuitry is to obtain the user monitoring data in response to verification of the sketch handler circuitry.

4. The apparatus of claim 3, wherein the verification of the sketch handler circuitry includes the token handler circuitry to record a connection fully qualified domain name (FQDN) of the publisher during connection to the publisher.

5. The apparatus of claim 4, wherein the verification of the sketch handler circuitry includes the token handler circuitry to assert a retrieved FQDN of the publisher against the connection FQDN of the publisher.

6. The apparatus of claim 1, wherein the sketch handler circuitry is to obtain the user monitoring data from the publisher by sending a request to the publisher including an access token.

7. The apparatus of claim 1, wherein the sketch handler circuitry is to obtain the user monitoring data from the publisher by:
obtaining encrypted user monitoring data from the publisher; and
decrypting the encrypted user monitoring data.

8. The apparatus of claim 1, wherein the sketch handler circuitry is to obtain second user monitoring data from a second publisher.

9. The apparatus of claim 8, wherein the sketch handler circuitry is to process the user monitoring data by aggregating the user monitoring data with the second user monitoring data.

10. At least one non-transitory computer readable storage medium comprising instructions that, when executed, cause at least one processor to:
establish trust with a publisher;
obtain user monitoring data from the publisher;
process the user monitoring data; and
send a portion of the processed user monitoring data to an audience measurement entity controller.

11. The at least one non-transitory computer readable storage medium of claim 10, wherein the instructions cause the at least one processor to establish trust with the publisher using a transport layer security (TLS) handshake.

12. The at least one non-transitory computer readable storage medium of claim 10, wherein the instructions cause the at least one processor to obtain the user monitoring data in response to verification of the at least one non-transitory computer readable storage medium.

13. The at least one non-transitory computer readable storage medium of claim 12, wherein the verification of the at least one non-transitory computer readable storage medium includes the instructions to cause the at least one processor to record a connection fully qualified domain name (FQDN) of the publisher during connection to the publisher.

14. The at least one non-transitory computer readable storage medium of claim 13, wherein the verification of the at least one non-transitory computer readable storage medium includes the instructions to cause the at least one processor to assert a retrieved FQDN of the publisher against the connection FQDN of the publisher.

15. The at least one non-transitory computer readable storage medium of claim 10, wherein the instructions are to cause the at least one processor to obtain the user monitoring data from the publisher by sending a request to the publisher including an access token.

16. The at least one non-transitory computer readable storage medium of claim 10, wherein the instructions are to cause the at least one processor to obtain the user monitoring data from the publisher by:
obtaining encrypted user monitoring data from the publisher; and
decrypting the encrypted user monitoring data.

17. The at least one non-transitory computer readable storage medium of claim 10, wherein the instructions are to cause the at least one processor to obtain second user monitoring data from a second publisher.

18. The at least one non-transitory computer readable storage medium of claim 17, wherein the instructions are to cause the at least one processor to process of the user monitoring data by aggregating the user monitoring data with the second user monitoring data.

19. A method, comprising:
establishing, by executing instructions with at least one processor, trust with a publisher;
obtaining, by executing instructions with the at least one processor, user monitoring data from the publisher;
processing, by executing instructions with the at least one processor, the user monitoring data; and
sending, by executing instructions with the at least one processor, a portion of the processed user monitoring data to an audience measurement entity controller.

20. The method of claim 19, further including establishing trust with the publisher using a transport layer security (TLS) handshake.

21-27. (canceled)
